(19) United States
(12) Patent Application Publication
(10) Pub. No.: US 2010/0125627 A1
(43) Pub. Date: May 20, 2010

(54) DOWNLOAD METHOD TO A SERVER SYSTEM AND THE SYSTEM THEREOF

(75) Inventors: Chih-Wei CHEN, TAIPEI CITY (TW); Hsiao-Fen LU, TAIPEI CITY (TW)

Correspondence Address: BRIAN M. MCINNIS, 12th Floor, Ruttonjee House, 11 Duddell Street, Hong Kong, HK

(73) Assignee: INVENTEC CORPORATION, TAIPEI CITY (TW)

(21) Appl. No.: 12/357,414

(22) Filed: Jan. 22, 2009

(30) Foreign Application Priority Data
Nov. 18, 2008 (TW) 97144528

(51) Int. Cl. G06F 15/16

(52) U.S. Cl. 709/203

(57) ABSTRACT

A download system is disclosed, which includes a server having a download server unit, a network device, and at least one computer. Each computer has a download agent unit respectively, and the computers are communicating with the server via the network device. A download request monitored in the computer is transferred to the server, and the download request is executed in the server. A download method thereof is also disclosed.

### RELATED APPLICATIONS

This application claims priority to Taiwan Application Serial Number 97144528, filed Nov. 18, 2008, which is herein incorporated by reference.

### BACKGROUND

1. Field of Invention

The present invention relates to a download method and system thereof. More particularly, the present invention relates to a download method to a server system.

2. Description of Related Art

With the rapid development in information technology, computers and their peripherals are now very popular. Users may download data or transfer file on computers. Users may use a file transfer protocol (FTP), a Peer to Peer (P2P) protocol, a hypertext transmission protocol (HTTP), or other protocols to download data or files. The download requests are mostly executed on the computers.

The download actions stop when the computer is shut down, thus the computer must be operated for a long time to download a large number of files. However, operating for a long time may waste lots of energy and reduce the life of the computer if the computer is operated for only downloading files. Also, when a notebook computer is downloading files, it cannot be moved around but must be remained connected to the data stream source.

Thus, there is a need to download files efficiently but not to keep the computer operating.

### SUMMARY

One embodiment of the invention provides a download method to a server system, which includes monitoring at least one computer; receiving at least one download request at the computer; providing the download request to a server; executing the download request at the server for obtaining a download file; and storing the download file in the server.

Another embodiment of the invention provides a download system, which includes a server having a download server unit, a network device, and at least one computer. Each computer has a download agent unit respectively, and the computers communicate with the server via the network device. A download request monitored in the computer is transferred to the server, and the download request is executed in the server.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a schematic diagram of an embodiment of the download system of the invention;

FIG. 2 illustrates a schematic diagram of another embodiment of the download system of the invention;

FIG. 3 illustrates a flow chart diagram of an embodiment of the download method to a server system of the invention; and

FIG. 4 illustrates a flow chart diagram of another embodiment of the download method to a server system.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

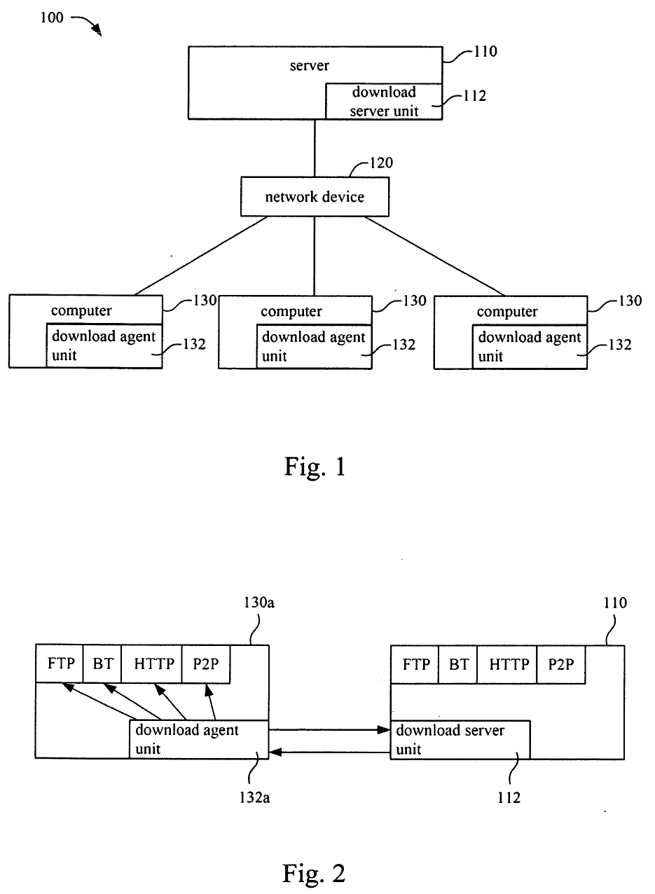

Refer to FIG. 1. FIG. 1 illustrates a schematic diagram of an embodiment of the download system of the invention. The download system 100 includes a server 110, a network device 120, and at least one computer 130. The computers 130 can communicate with the server 110 via the network device 120. The server 110 has a download server unit 112, and each computer 130 has a download agent unit 132 respectively.

The server 110 can be a home server or an office server. The computers 130 may include a notebook computer, a desktop computer, or other electronic devices with download function. The network device 120 can be a hub, a router, or a switch.

The computers 130 may be shut down and not always remain on. The server 110 on the other hand will always typically remain turned on. The download system 100 in this embodiment has the download agent unit 132 in the computers 130 and the download server unit 112 in the server 110, that can transfer the download requests of the computers 130 to the server 110 by the network communication thereof when the download requests are monitored, and the download requests are executed in the server 110, but not in the computers 130.

Refer to FIG. 2. FIG. 2 illustrates a schematic diagram of another embodiment of the download system of the invention. The computer 130a has a download agent unit 132a to monitor the download software in the computer 130a. When a download request is monitored, the download agent unit 132a may transfer the download request to the download server unit 112 of the server 110 through the network communication.

The protocol of the download request can be a file transfer protocol (FTP), a hypertext transmission protocol (HTTP), or a P2P protocol.

The download request can be executed at the download server unit 112 of the server 110, and the user can shut down the computer 130a when the download list has been selected. The download request is executed in the download server unit 132a and a download file thereof can be stored in the server 110 temporarily.

Then server 110 can check whether the computer 130a is connected to the server 110 or not after the download request is accomplished. Then, the download file in the server 110 can be transferred to the computer 130a when the computer 130a is power-on and connected to the server 110.

Refer to FIG. 1 and FIG. 2 simultaneously, the download system 100 with the download agent unit 132 and the download server unit 112 can transfer the download request from the computers 130 to the server 110, and the download requests are executed in the server 110. Thus the computers 130 can be shut down.

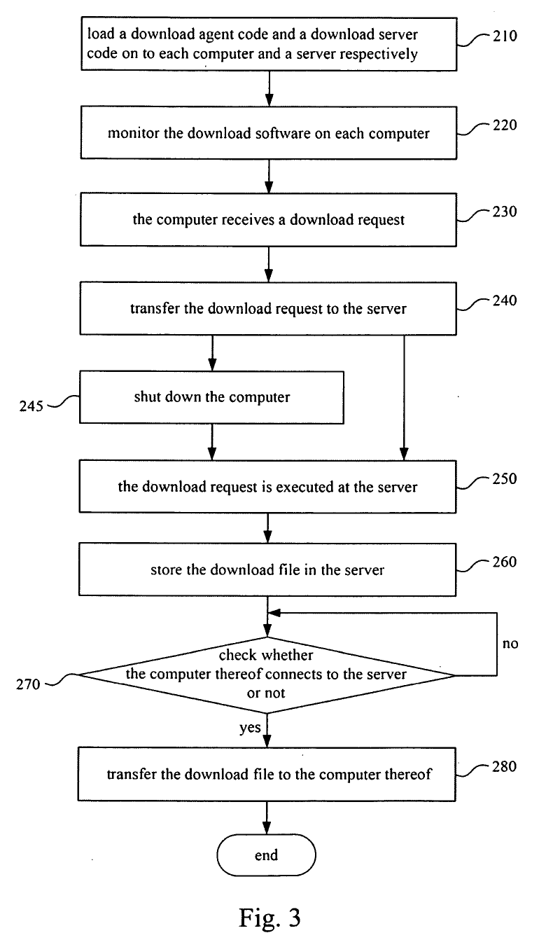

Refer to FIG. 3. FIG. 3 illustrates a flow chart diagram of an embodiment of the download method to a server system of the invention. In Step 210 a download agent code is loaded on to each computer and a download server code is loaded on to the server to provide the download agent unit in each computer and the download server unit in the server as shown in FIG. 1.

Then, in step 220 the download agent unit monitors the download software on each computer respectively, and in step 230 the computer receives a download request when the download software is operated.

In Step 240 the download agent units transfer the download request to the server. The embodiment could optionally include step 245 to shut down the computer when the download request thereof has been transferred to the server.

In step 250, the download request can be executed at the server and the server can obtain the download file corresponding to the download request, and the download file is stored in the server in step 260.

Step 270 checks to see whether the computer corresponding to the download file connects to the server or not after the download request has been accomplished. If the computer is connected to the server, then in step 280 the download file is transferred to the computer thereof and a message is sent to the computer.

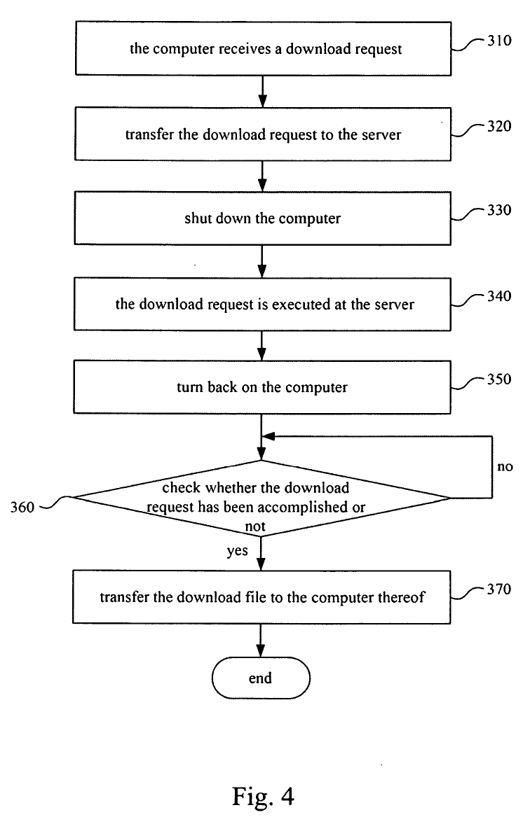

Refer to FIG. 4. FIG. 4 illustrates a flow chart diagram of another embodiment of the download method to a server system. In Step 310 the computer receives the download request. Then the download agent unit in the computer transfers the download request to the download server unit in the server in step 320. Then, in step 330 the computer is shut down. The download request is executed on the server in step 340.

In Step 350 the computer that was shut down in step 330 is turned back on and the computer connects to the server. In step 360 the computer checks whether the download request has been accomplished or not. The download file corresponding to the download request can be stored in the server when the download request has been accomplished. Then, in step 370 the downloaded file is transferred to the computer.

The download requests can be transferred from the computers to the server in the above embodiment of the present invention. The download requests are executed at the server, which is always in the power-on state, thus the download process would not be quit when the computer is shut down. The computers can be shut down to save energy after the download requests are transferred to the server.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A download method to a server system comprising:
monitoring at least one computer;
receiving at least one download request on the computer;
providing the download request to a server;
executing the download request on the server for obtaining a download file; and
storing the downloaded file in the server.

2. The download method to a server system of claim 1, wherein the download request is executed in a home server.

3. The download method to a server system of claim 1, further comprising checking whether the computer connects to the server or not after the download request is accomplished.

4. The download method to a server system of claim 3, further comprising transferring the download file to the computer.

5. The download method to a server system of claim 1 further comprising shutting down the computer after the download request is provided to the server.

6. The download method to a server system of claim 1, wherein the download request is executed only at the server.

7. The download method to a server system of claim 1, further comprising loading a download agent code to the computer for monitoring and providing the download request to the server.

8. The download method to a server system of claim 1, further comprising loading a download server code to the server.

9. A download system comprising:
a server having a download server unit;
a network device; and
at least one computer having a download agent unit respectively and communicating with the server via the network device, wherein a download request monitored in the computer is transferred to the server, and the download request is executed in the server.

10. The download system of claim 9, wherein the server is a home server.

11. The download system of claim 9, wherein the computer is a desktop computer or a notebook computer.

12. The download system of claim 9, wherein the network device comprises a hub, a router, or a switch.

13. The download system of claim 9, wherein a protocol the download request is a file transfer protocol (FTP), a hypertext transmission protocol (HTTP), or a peer to peer (P2P) protocol.
